(19) United States
(12) Patent Application Publication
(10) Pub. No.: US 2020/0132476 A1
(43) Pub. Date: Apr. 30, 2020

(54) METHOD AND APPARATUS FOR PRODUCING A LANE-ACCURATE ROAD MAP

(71) Applicant: Robert Bosch GmbH, Stuttgart (DE)

(72) Inventors: Oliver Roeth, Elze (DE); Daniel Zaum, Sarstedt (DE)

(21) Appl. No.: 16/617,774

(22) PCT Filed: Mar. 23, 2018
(86) PCT No.: PCT/EP2018/057506

§ 371 Date: Nov. 27, 2019

(30) Foreign Application Priority Data
Jun. 1, 2017 (DE) 10 2017 209 346.3

(51) Int. Cl. G01C 21/32; G01C 21/36; G01C 21/20; G06K 9/00; G06T 5/00

(52) U.S. Cl. CPC G01C 21/32; G01C 21/367; G06T 2207/30256; G06K 9/00798; G06T 5/002; G01C 21/20

(57) ABSTRACT

A method for producing a lane-accurate road map. The method includes providing a digital road-accurate road map, providing a trajectory data record, identifying at least one road with segmenting of the road-accurate road map into at least one road segment, modeling the road segment in a road model, the road model having parameters for describing lanes of the road, random variation of parameter values of at least a part of the parameters of the road model through random selection of a change operation of the road model, and assigning at least a part of the trajectory data of the trajectory data record to the road model with ascertaining of at least one probability value for the road model. Based on the ascertained at least one probability value, optimal parameter values of the road model are ascertained, and based on this a lane-accurate road map is produced.

### FIELD

The present invention relates in general to the production of road maps. In particular, the present invention relates to a method and to a data processing device for producing a digital road map that is lane-accurate.

### BACKGROUND INFORMATION

In particular with regard to automated and/or autonomous driving of vehicles, in the past, various methods have been developed for producing digital road maps.

In a paper by Uruwaragoda et al., 2013, “Generating Lane Level Road Data from Vehicle Trajectories Using Kernel Density Estimation,” Proceedings of the 16th International IEEE Annual Conference on Intelligent Transportation Systems (ITSC 2013), 201, for example a method is described for estimating a number and a width of lanes on roads. For this purpose, starting from a road-accurate road map, the center line of the road is sectioned at right angles at discrete distances. The points of intersection of each of these perpendiculars with trajectories of vehicles on the road are calculated, and in each case a core density estimation is carried out. In this way, support points along the road are produced that contain information about the number of lanes and a lane width, and that can subsequently be linked.

In a paper by Schroedel et al., “Mining GPS Traces for Map Refinement,” Data Mining and Knowledge Discovery, 2004, 9, information about the number of lanes and a lane width is derived without prior map knowledge, in that an algorithm first divides the trajectories of vehicles into segments and identifies the center line. Along this center line, perpendicular distances to the trajectories of the vehicles are categorized using density estimation methods in order to enable conclusions about the lanes.

In Betaille et al., “Creating Enhanced Maps for Lane-Level Vehicle Navigation,” IEEE Transaction on Intelligent Transportation Systems, 2010, 4, 2010, 10, a modeling-based approach is pursued in which models described by clothoids are adapted to measured trajectory data of vehicles.

### SUMMARY

Through specific example embodiments of the present invention, an improved method for producing a more detailed and precise lane-accurate road map, and a corresponding data processing device, can advantageously be provided.

An aspect of the present invention relates to a method for producing and/or generating a lane-accurate road map, in particular a digital lane-accurate road map. The method has the following steps:
providing a digital road-accurate road map for describing the course of at least one road;
providing a trajectory data record that has a plurality of trajectory data of traffic participants along the at least one road;
identifying and/or ascertaining the at least one road, with segmenting, dividing, and/or partitioning the road-accurate road map into at least one road segment;
modeling the road segment in at least one road model, the road model having a plurality of parameters for the geometrical and/or topological description of lanes of the road;
random varying and/or changing, in particular multiple random varying and/or changing, of parameter values at least of a part of the parameters of the road model, through random selection of a change operation of the road model in order to change parameter values;
assigning at least a part of the trajectory data of the trajectory data record to the road model, with ascertaining of at least one probability value for the road model, the probability value correlating with a goodness and/or quality of a mapping, imaging, and/or imitation of the trajectory data by the road model;
ascertaining, based on the ascertained at least one probability value, optimal parameter values of at least a part of the parameters of the road model; and
producing a lane-accurate road map based on the optimal parameter values of the road model.

Here and in the following, the “digital road-accurate road map” can designate a road map that contains only information relating to a road course and/or a road, but not containing information regarding individual lanes on the road. For example, the road-accurate road map can have one or more nodes and edges, where an edge can be used to represent a road and/or a road segment and a node can represent an intersection. The road-accurate map can as it were designate a graph with nodes and edges. The edges can be given and/or represented by arrows and the nodes can be given and/or represented by points in the graph and/or in the road-accurate road map.

The term “lane-accurate road map” can designate a digital road map and/or a graph that has information relating to individual lanes. The lane-accurate road map can in particular contain information relating to a geometry of individual lanes, for example relating to a lane width, the number of lanes, a distance between lanes having opposite directions of travel, and/or a curvature of a road and/or of a road segment. These geometrical items of information can be taken into account and/or contained for example in at least a part of the “parameters for geometrical description of lanes of the road.” The “parameters for geometrical description” can include, as it were, parameters for describing the number of lanes, a width of individual lanes, a curvature of a road or of individual lanes, and/or a distance between lanes having opposite directions of travel. In addition, the lane-accurate road map can contain information relating to a topology of the lanes, where the topology can describe a connection path, a connection, and/or a connectivity between individual lanes. This topological information can be taken into account and/or contained for example in at least a part of the “parameters for topological description of lanes of the road.” The “parameters for typological description of lanes of the road” can include parameters for describing a connection path, a connection, a connectivity between individual lanes, a disappearance of individual lanes in the road segment, and/or a producing of an additional lane in the road segment.

The term “trajectory data” can designate geographical coordinates such as GPS coordinates (Global Positioning System) and/or GNSS data (Global Navigation Satellite System) that describe a trajectory, a movement profile, a driving path, and/or a movement of a traffic participant, such as a vehicle, a motorcycle, and/or a pedestrian, along a road and/or at an intersection. The term “trajectory data record” can as it were designate a set of such trajectory data of one or more traffic participants.

In addition, the term “modeling of the road segment in at least one road model” can designate a mapping, an imaging, a copying, and/or an imitation of the road segment in the at least one road model. Here, the road model can designate a mathematical and/or modeling-based abstraction and/or description of the road segment.

In the following, the method according to the present invention is summarized. The road-accurate road map can be read for example in a data processing device, from a data storage device of the data processing device. The road-accurate road map can include one or more nodes and/or one or more edges for the geographical description of one or more roads and/or of one or more intersections. The providing of the road-accurate road map can thus include a reading in of the road-accurate road map and/or a reading in of the at least one edge and/or of the at least one node. The road-accurate road map can then be analyzed, for example on the basis of the at least one node and/or the at least one edge, and can be subdivided and/or segmented into at least one road segment. In particular, the road-accurate road map can have a plurality of roads that can each be subdivided into individual road segments, for example based on the nodes and/or edges. In other words, roads and/or the at least one road can be identified based on the nodes and/or edges. Subsequently, each of the identified road segments can be mapped, modeled, imaged, and/or imitated in a separate road model. After this, for each of the road models, each of which can be assigned to a road segment, at least a part of the parameters of the respective road model can be varied and/or changed. In particular, the parameters of each road model can be iteratively varied multiple times, such that parameters of different road models can be varied simultaneously or one after the other in a temporal sequence. The parameter values can be varied independently of the trajectory data. In addition, the trajectory data can be assigned to the respective road models, for example on the basis of geographical coordinates of the trajectory data and/or of the road-accurate road map. Here it can be ascertained which of the trajectory data are located in one of the road segments, so that, based on this, the trajectory data associated with the individual road models can be ascertained. In particular, the step of modeling in the road model can take place before the step of allocating the trajectory data to the road model. Subsequently, it can be checked how well the trajectory data have been imitated and/or imaged by the respective road model; a probability value can be ascertained as a measure of the goodness and/or quality of such a mapping for each of the road models. In the context of the present invention, the probability can as it were designate a measure for a quality and/or goodness of a mapping, imaging, and/or imitation of the trajectory data by the corresponding road model. In particular, for each of the road models a plurality of probability values can be ascertained through multiple independent varying of a part of the parameters of each road model. From the probability values ascertained for each of the road models, at least one probability value can then be selected in each case that is higher or is a highest probability value compared to other probability values of the same road model, and which can thus correspond to an optimal configuration of the associated road model and/or to the optimal parameter values of the associated road model. In addition, in the context of the ascertaining of the highest probability value, the so-called simulated annealing method can be used. This can bring it about that change operations that worsen an agreement between the road model and trajectory data will be accepted less frequently as the time of the optimization process progresses, and/or that the optimization of the road model ends directly in the optimal parameter values of the road model, i.e. the most probable and/or best road model. Finally, in this way the probability values and the parameter values of the individual road models can be iteratively optimized. The optimal parameter values of the individual road models can be selected and/or chosen and can thus represent a lane-accurate road map. In other words, the lane-accurate road map can be given by the optimal parameters of the at least one road model. The method according to the present invention can thus provide that one or more road segments are mapped in one or more road models, and subsequently the optimal parameter values of the one road model or of the road models are ascertained iteratively.

The example method according to the present invention can therefore designate a modeling-based optimization method based on which an accurate topological and geometrical road map of a traveled road network can advantageously be derived and/or ascertained from movement profiles, trajectory data, and/or driving trajectories of one or more traffic participants. In particular, a number, a course, a width, a distance, and/or a connectivity of individual lanes can be determined with a high degree of accuracy. This can take place for straight road segments, curved segments, and/or for intersection segments.

The present invention can in particular be regarded as being based on the findings described below. With the availability of connectivity solutions in many commercially produced vehicles, and/or via smartphone applications, already today innumerable movement profiles and/or trajectory data can be acquired from vehicles and/or traffic participants. This can therefore represent a source of data that can be made available easily, at low cost, and in good time. At the same time, the worldwide mapping of the road network, extensive in its surface coverage and accurate, is becoming more and more important in the context of automatic driving. The method according to the present invention can therefore advantageously enable an accurate mapping of a road network based on an analysis of known movement profiles, trajectory data, and/or driving trajectories, such as of a large fleet of vehicles. For example in comparison with a mapping made by highly specialized measurement vehicles, as is frequently carried out by traditional map producers, the trajectories used for the method according to the present invention can be provided at low cost, easily, and in large quantities, so that a low-cost, rapid, extensive and precise mapping of a road network can be carried out.

According to a specific embodiment, the optimal parameter values are ascertained based on a Monte Carlo method, in particular based on a reversible jump Markov chain Monte Carlo method (RJMCMC). In particular, the random selection of a change operation for the random varying of the parameter values of at least a part of the parameters of the road model can be carried out based on the Monte Carlo method and/or the reversible jump Markov chain Monte Carlo method. Here, all, or at least a part, of the change operations can be assumed to be uniformly distributed, and, based on a random number, one of the change operations can be selected, as if by rolling dice, for the random variation of at least a part of the parameter values. After the random selection of a change operation this change operation can be carried out, and subsequently it can be decided whether the change caused thereby in the parameter values is to be accepted or rejected. In the course of the RJMCMC method, in general input data, such as the trajectory data, can be realized as a realization of a random experiment, a distribution of the input data being implied by the road network taken as a basis, and/or by the road model. The goal of the RJMCMC method can be to reconstruct the unknown distribution, such as the actual road network, on the basis of the road model. Here, the road model and/or the parameter values of the road model can be varied randomly and/or independently of the trajectory data. Subsequently, depending on the ascertained probability value and/or depending on the magnitude of the ascertained probability value, the associated parameter values, or the change of the parameter values, can be rejected or accepted, for example based on a comparison with a threshold value and/or based on an evaluation metric. A simulated annealing method may also be used in the ascertaining of the optimal parameter values.

According to a specific embodiment, the road model has at least one road block for modeling a number of lanes that is constant at least in a partial area of the road segment. Alternatively or in addition, the road model has at least one connection block for modeling, based on at least one geometrical parameter matrix and at least one topological parameter matrix, of a number of lanes that changes at least in a partial area of the road segment, values of the geometrical parameter matrix describing a change of the number of lanes within the road segment, and values of the topological parameter matrix describing a connection between individual lanes within the road segment. In other words, it can be provided to model each identified road segment using at least one road block and a connection block of the road model. In particular, it can be provided to model each identified road segment through a road block situated between two connection blocks. Through the use of a respective road block in each road segment that models a constant number of lanes, a computing expense can advantageously be reduced. In addition, through the use of at least one connection block per road segment, a flexibility of the road model can be increased, because possible changes in a geometry and/or topology of two adjacent road segments can reliably and comprehensively be modeled and/or taken into account in the connection block. The connection block can have a respective geometrical and a respective topological parameter matrix for each direction of travel of a lane. In other words, the connection block can have two geometrical and two topological parameter matrices for modeling a geometry and/or topology of lanes having different directions of travel.

According to a specific embodiment, the step of modeling the road segment in the road model has the following substeps:
parameterizing the road segment in a unit interval, so that each point of the road in the road segment is defined via a parameterization value in the unit interval;
segmenting and/or dividing the road segment into at least one road block and at least one connection block of the road model;
modeling, imaging, and/or imitating a disappearance or a production of a lane within a road segment, based on at least one geometrical parameter matrix of the connection block;
ascertaining values of the geometrical parameter matrix and/or values of the topological parameter matrix based on a random selection of a change operation of the road model.

The step of parameterization can include a step of ascertaining a length and/or a longitudinal extension of the road segment and a step of norming to the ascertained length. In other words, each road segment can be parameterized one-dimensionally, whereby, advantageously, each point of the road segment can be described by a value between zero and one, i.e. by a value of the unit interval.

According to a specific embodiment, the digital road-accurate road map has at least one intersection and a plurality of roads connected to the intersection, the method further having the following steps:
identifying the at least one intersection with segmenting and/or division of the road-accurate road map into at least one intersection segment;
modeling, mapping, imaging, and/or imitating the intersection segment in at least one intersection model, the intersection model having a plurality of parameters for the geometrical and/or topological description of lanes of the intersection;
random varying and/or changing, in particular multiple random varying, of parameter values of at least a part of the parameters of the intersection model, through random selection of a change operation of the intersection model in order to change parameter values;
assigning at least a part of the trajectory data of the trajectory data record to the intersection model, with ascertaining of at least one probability value for the intersection model, the probability value correlating with a goodness and/or quality of a mapping of the trajectory data by the intersection model;
ascertaining optimal parameter values of at least a part of the parameters of the intersection model, based on the ascertained at least one probability value; and
creating a lane-accurate road map based on the optimal parameter values of the intersection model.

According to the present invention, it can therefore be provided to model each road segment of the road-accurate road map through a road model and each intersection segment through an intersection model. In this way, advantageously the individual properties of intersections and roads are modeled, and computing expense can be reduced. In addition, this can increase the accuracy of the produced lane-accurate road map. Here, an intersection in the road-accurate road map may for example be identified by identifying a node connected to more than two edges.

According to a specific embodiment, the intersection model has an external intersection model for modeling a navigable surface of the intersection, based on a distance parameter (d) and an angle parameter (a). Alternatively or in addition, the step of modeling of the intersection segment in the intersection model includes the following substeps:
ascertaining an intersection node in the road-accurate road map, for example based on an ascertaining of a node connected to more than two edges in the road-accurate road map;
ascertaining a number of edges, connected to the intersection node, of the road-accurate road map, with ascertaining of a number of roads connected to the intersection, where the number of ascertained edges can correspond to the number of roads connected to the intersection;
generating and/or producing a number of intersection arms, corresponding to roads connected to the intersection, each of the intersection arms being defined by a distance parameter (d) indicating a distance of a center of the intersection to a limit surface of the intersection along the respective intersection arm, and each of the intersection arms being defined by an angle parameter (a) indicating an angle of rotation between the respective intersection arm and a reference direction, for example a reference intersection arm.

Through the external intersection model, advantageously a connection cross-section between the intersection arms and the roads connected thereto can be precisely modeled and/or calibrated to one another, for example with regard to the number of lanes, a width of lanes, a distance between lanes having opposite directions of travel, and/or a curvature.

According to a specific embodiment, the intersection model has an internal intersection model for modeling—based on a factor matrix (F) of the intersection model—lanes leading into the intersection, lanes leading out from the intersection, and a course of lanes over a navigable surface of the intersection.

Alternatively or in addition, the step of modeling of the intersection segment in the intersection model has the following substeps:
modeling, imaging, mapping, and/or imitating at least a part of lanes leading into the intersection, at least a part of lanes leading out from the intersection, and a curve of at least a part of lanes leading over an intersection surface of the intersection, based on a factor matrix (F), where values of the factor matrix (F) describe a curve and a connection of lanes over the intersection surface; and
ascertaining values of the factor matrix (F) based on at least a part of the trajectory data of the trajectory data record.

Through the internal intersection model, advantageously every possible connection of individual lanes via the intersection surface can be precisely modeled. In addition, by ascertaining the values of the factor matrix based on the trajectory data, the number of possible connections of the lanes via the intersection, and thus a computing expense, can be reduced, because the trajectory data can always represent actual and realistic connections of the lanes.

According to a specific embodiment, the road model and/or an intersection model each have a number parameter (L) for describing the number of lanes, a width parameter (W) for describing a width of individual lanes, a curvature parameter (C) for describing a curvature of a road, and a distance parameter (G) for describing a distance between lanes having opposite direction of travel. Parameters named above can be parameters of an internal intersection model and/or of an external intersection model of the intersection model. Parameters named above can also be parameters of a road block and/or of a connection block of the road model. The distance between lanes having opposite direction of travel can for example describe a constructive separation between adjacent lanes having opposite directions of travel. Through parameters listed above of the road model and/or of the intersection model, it can advantageously be ensured that roads and/or intersections can be precisely modeled, and that in this way a precise lane-accurate road map can be produced.

According to a specific embodiment, the road model and/or an intersection model has at least one change operation selected from the list made up of: an insertion operation for inserting a connection block into a road block, a fusing operation for fusing two road blocks and a connection block to form one road block, an adaptation operation for adapting a parameterization value for parameterizing a longitudinal extension of a road, an addition operation for adding a lane, a removal operation for removing a lane, a distance adaptation operation for adapting a distance between lanes having opposite directions of travel, a width adaptation operation for adapting a width of a lane, and a curvature adaptation operation for adapting a curvature of a road in the road model, of a road block, and/or of a connection block of the road model. Using change operations listed above, advantageously the parameter values of all and/or at least of a large part of the parameters of the road model and/or of the intersection model can be varied through the random selection of one of the change operations. In addition, the change operations can reliably map all possible and realistic changes in a real road network, which in turn can permit the creation of a precise and realistic lane-accurate road map.

According to a specific embodiment, the method further includes a step of rejecting or accepting parameter values varied randomly based on the random selection of a change operation, based on an evaluation metric that describes the quality of the mapping of the trajectory data by the road model and/or an intersection model. Here the evaluation metric has a first term describing an agreement between the trajectory data and the road model and/or an intersection model. In addition, the evaluation metric has a second term for taking into account at least one prespecified characteristic variable of a road geometry, in particular a characteristic variable relating to a lane width and/or a road width. For example, for a characteristic variable there can be a stochastic specification relating to the values of the characteristic variable, which can predetermine the dimension of the characteristic variable.

For example, a lane width can be defined using a normal distribution, so that a lane width is sought in the vicinity of around 3.25 m. In this way, it can be avoided that lane widths of, e.g., 6 m are examined. Via the evaluation metric, any prior knowledge about a road geometry and/or an intersection geometry can thus advantageously be taken into account. For example, construction standards and/or construction guidelines for road construction can be taken into account in the evaluation metric. In this way, it can in particular be ensured that the method according to the present invention enables the production of realistic lane-accurate road maps. Computing time can also be reduced in this way.

A further aspect of the present invention relates to a data processing device for ascertaining a lane-accurate road map based on a digital road-accurate road map. Here, the data processing device is set up to carry out the method as described above and in the following. The term “set up” can mean that the data processing device for example has a program element that, when executed, for example on a processor of the data processing device, causes the data processing device to carry out the method according to the present invention. For example, the program element can have corresponding software instructions.

All features, steps, functions, and/or characteristics described above and in the following in relation to the method according to the present invention can be features, functions, and/or characteristics of the data processing device as described above and in the following, and vice versa.

According to a specific embodiment, the data processing device has a data storage device for storing a digital road-accurate road map, and a processor. On the data storage device, in addition a program element can be stored that, when executed on the processor, causes the data processing device to carry out the method according to the present invention.

### BRIEF DESCRIPTION OF THE DRAWINGS

Below, exemplary embodiments of the present invention are described in detail with reference to the Figures.

FIG. 1 shows a data processing device according to an exemplary embodiment of the present invention.

FIG. 2 shows a flow diagram illustrating steps of a method for producing a lane-accurate road map according to an exemplary embodiment of the present invention.

FIGS. 3A through 3D each illustrate a method for producing a road-accurate road map.

FIGS. 4A through 4C each illustrate steps of a method for producing a lane-accurate road map according to an exemplary embodiment of the present invention.

FIGS. 5A through 5C each illustrate a road model according to an exemplary embodiment of the present invention.

FIGS. 6A through 6D each illustrate an intersection model according to an exemplary embodiment of the present invention.

FIGS. 7A through 7E each illustrate change operations according to an exemplary embodiment of the present invention.

FIGS. 8A and 8B each illustrate an application of an evaluation metric according to an exemplary embodiment of the present invention.

The Figures are schematic and are not to scale. In the Figures, identical, identically functioning, or similar elements have been provided with the same reference characters.

### DETAILED DESCRIPTION OF EXAMPLE EMBODIMENTS

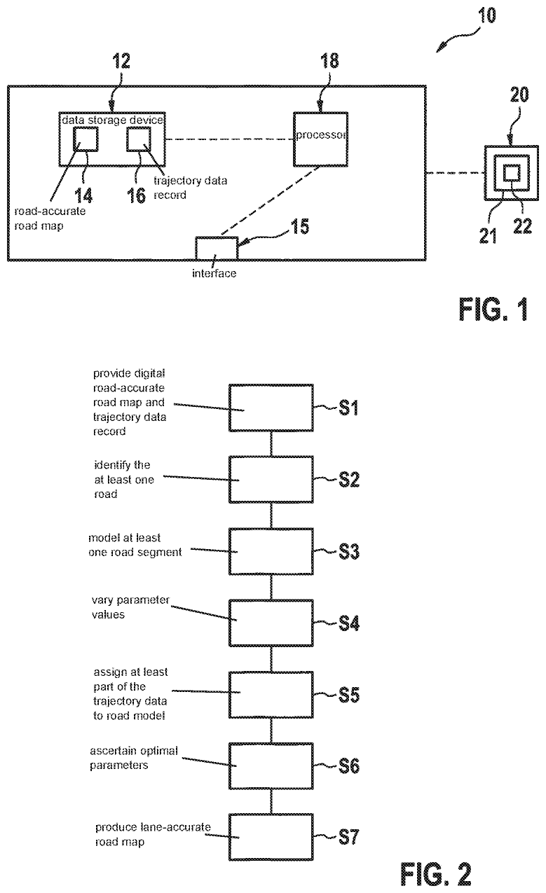

FIG. 1 shows a data processing device 10 according to an exemplary embodiment of the present invention.

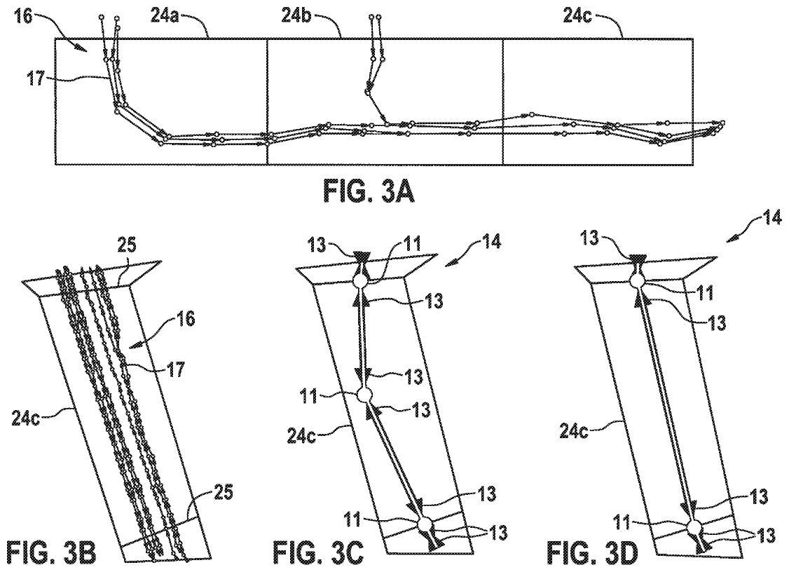

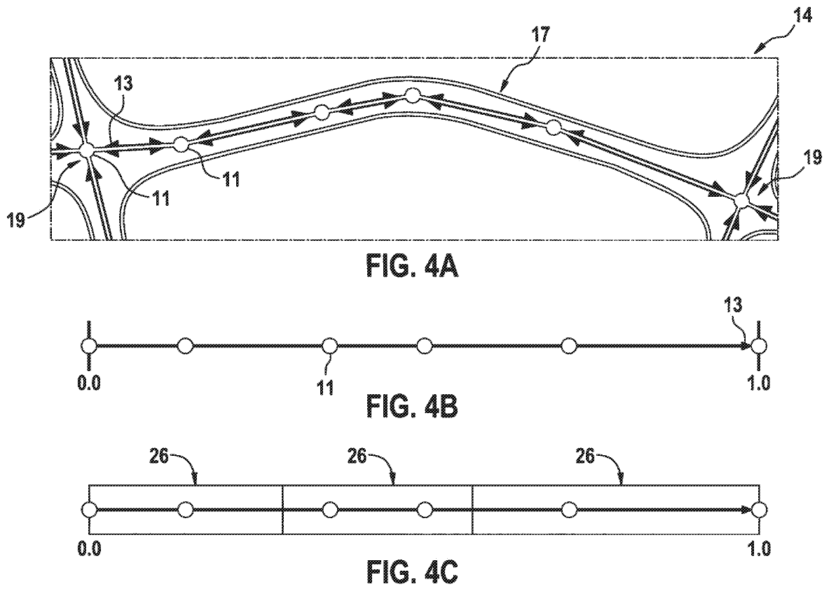

Data processing device 10 has a data storage device 12. In data storage device 12, for example a road-accurate road map 14 can be stored that can have at least one node 11 (see, e.g., FIG. 3C and 3D) and/or an edge 13 (see, e.g., FIG. 3C and 3D), for describing a course of a road 17 (see FIG. 4A) and/or an intersection 19 (see FIG. 4A). In particular, road-accurate road map 14 can have a plurality of nodes 11 and/or edges 13 for describing a road network having a plurality of roads 17 and/or intersections 19. In data storage device 12, a trajectory data record 16 can also be stored that can have a plurality of trajectory data 27 (see FIG. 3B) from traffic participants.

Alternatively or in addition, data processing device 10 can have an interface 15 via which lane-accurate road map 14 and/or trajectory data record 16 of data processing device 10 can be provided. Interface 15 can for example be realized wirelessly, so that road-accurate road map 14 and/or trajectory data record 16 can for example be received wirelessly via WLAN, Bluetooth server, and/or the like, for example from at least one server and/or via a cloud environment.

In addition, data processing device 10 has at least one processor 18. On processor 18, a program element, for example stored in data storage device 12, can be carried out that instructs data processing device 10 and/or processor 18 to carry out the method according to the present invention for producing a lane-accurate road map 22 as described above and in the following.

Optionally, data processing device 10 can have an operating element 20 for inputting an operating input, for example by a user. The operating element can additionally have a display element 21 for displaying the road-accurate road map 14, the lane-accurate road map 22, and/or the trajectory data record 16.

FIG. 2 shows a flow diagram illustrating steps of a method for producing a lane-accurate road map 22 according to an exemplary embodiment of the present invention.

In a first step S1, a digital road-accurate road map 14 is provided for describing a course of at least one road 17 and/or at least one intersection 19, for example via data storage unit 12 and/or via interface 15 of data processing device 10. In particular, road-accurate road map 14 can have a plurality of roads 17 and intersections 19. In addition, in step S1 a trajectory data record 16 is provided that has a plurality of trajectory data 27 of traffic participants along the at least one road 17 and/or the at least one intersection 19. Trajectory data record 16 can also be provided via data storage unit 12 and/or via interface 15 of data processing device 10.

In a step S2, the at least one road 17 is identified, with segmenting of the road-accurate road map 14 into at least one road segment 26 (see FIG. 4C). This can take place based on nodes 11 and/or edges 13 of road-accurate road map 14. Optionally, in step S2 at least one intersection can take place by segmenting of road-accurate road map 14 into at least one intersection segment 19a. In particular, in step S2 the road-accurate road map 14 can be subdivided into a plurality of road segments 26 and a plurality of intersection segments 19a.

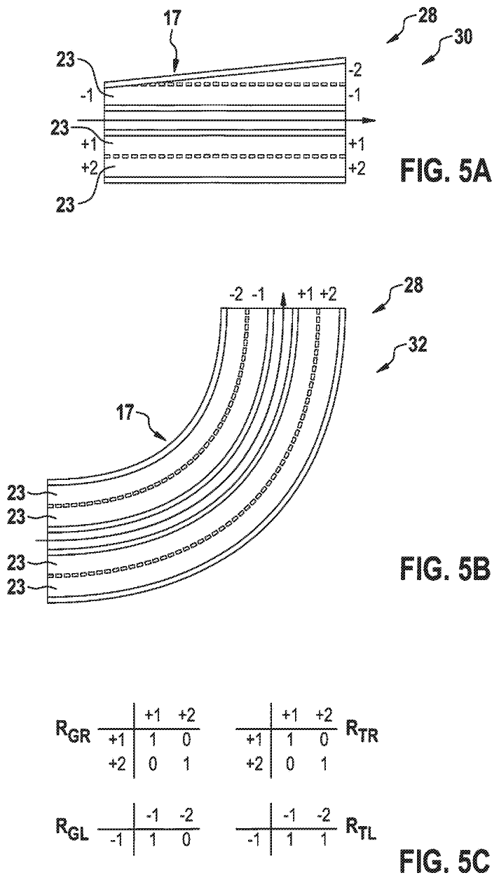

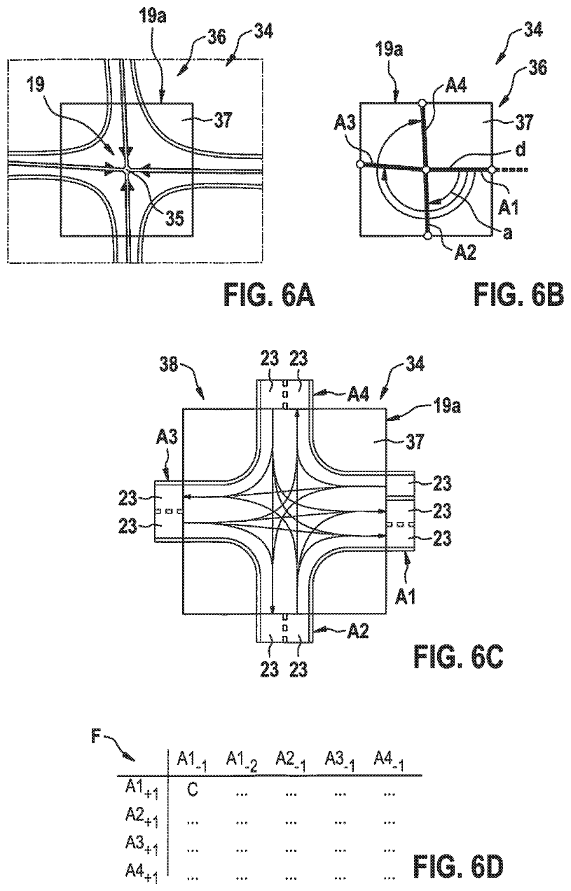

In a further step S3, the at least one road segment 26 is modeled in at least one road model 28 (see FIG. 5A, 5B). In particular, in step S2 all road segments 26 can each be modeled in a road model 28. In addition, in step S3 the at least one intersection 19 can be modeled in an intersection model 34 (see FIGS. 6A-6C). In particular, each of the intersections 19 can be modeled in a separate intersection model 34. Each of the road models 28 and/or each of the intersection models 34 has a plurality of parameters for the geometrical and/or topological description of lanes 23.

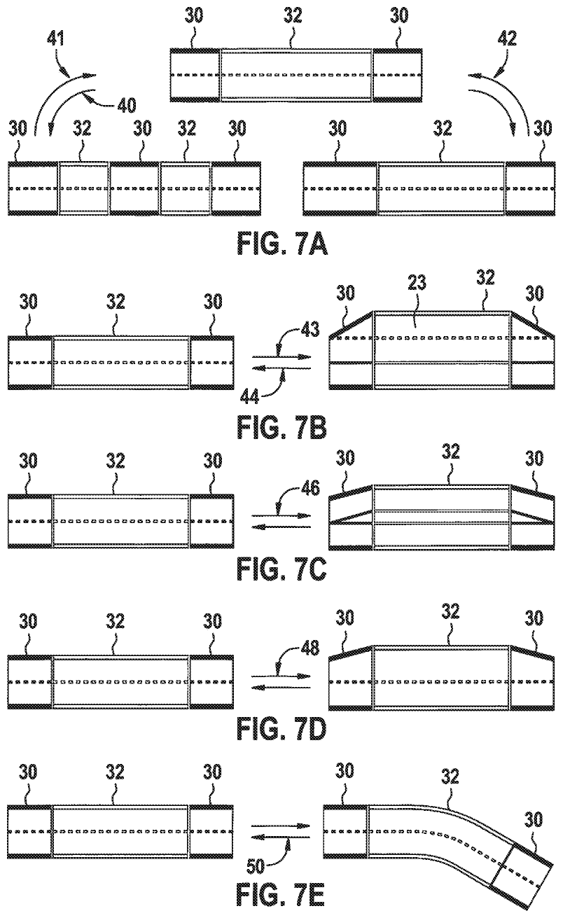

In a further step S4, parameter values of at least a part of the parameters of road model 28 and/or of intersection model 34 are varied through random selection of a change operation 40, 41, 42, 43, 44, 46, 48, 50 (see FIG. 7A-7E) of road model 28 and/or of intersection model 34. In particular, in step S4 the parameter values of all road models 28 and of all intersection models 34 can be varied multiply and iteratively.

In a further step S5, at least a part of the trajectory data 27 of trajectory data record 16 is assigned to road model 28, with ascertaining of at least one probability value for road model 28. In particular, in step S5 the trajectory data 27 can be assigned to each of the road models 28, with ascertaining in each case of at least one probability value for each of the road models 28. In addition, in step S5 the trajectory data 27 can be assigned to the at least one intersection model 34, by ascertaining at least one probability value in step S5 the trajectory data 27 can be assigned to each of the intersection models 34 by ascertaining in each case at least one probability value for each of the intersection models 34. The probability values correlate with the quality of a mapping of the trajectory data 27 by the respective road model 28 and/or the respective intersection model 34.

In a step S6, based on the ascertained at least one probability value, optimal parameter values are ascertained for at least a part of the parameters of road model 28 and/or of intersection model 34. In particular, optimal parameter values can be ascertained for each of the road models 28 and/or for each of the intersection models 34.

In a step S7, a lane-accurate road map 22 is produced based on the optimal parameter values of the at least one road model 28 and/or of the at least one intersection model 34. In particular, the lane-accurate road map 22 can be given by the optimal parameter values of all road models 28 and/or all intersection models 34.

FIGS. 3A through 3D each illustrate a method for producing a road-accurate road map 16. The road-accurate road map 16 produced in this way can be used as a basis for the production of a lane-accurate road map 22. Correspondingly, all the steps described in relation to FIGS. 3A through 3D can also be part of the method according to the present invention for producing a lane-accurate road map 22.

FIG. 3A illustrates a trajectory data record 16 having a plurality of collected trajectory data 27 and/or trajectories 27. In addition, FIG. 3A illustrates a segmenting and/or division of the trajectory data 27 into various traffic scenarios and/or segments 24a-c. FIG. 3A schematically shows a first segment 24a, which describes a curve, a second segment 24b, which describes an intersection, and a third segment that describes a road. Segments 24a-c are here ascertained as described in the following.

The trajectory data 27 collected from a fleet of vehicles, for example GNSS trajectories 27, can, in any number, describe a likewise arbitrarily large traffic scenario. In order to make it possible to handle the dimension of the data to be evaluated, trajectories 27 can be partitioned in automated fashion according to a logical system. For this purpose, trajectory data 27, which can also be referred to as input data, can be divided into different traffic scenarios 24a-c and/or different segments 24a-c, where each of the segments 24a-c can describe a straight road, a curve, or an intersection.

In an automated method, each trajectory 27 can be run through and individual measurement points can be identified as potential curve points based on boundary values in a change of a driving angle and/or of a speed. These points thus lie either on a curve or an intersection, or may have originated from measurement errors. Subsequently, all identified points can be clustered, aggregated, and/or combined via distance boundary values. Starting from a specified quantity of combined points, the cluster is regarded as a curve and/or as an intersection. Based on the found curves and/or intersections, a triangulation can then be done, and then a Delaunay decomposition can be constructed. Each cell of this decomposition can finally describe a separate traffic situation 24a-c and/or a segment 24a-c. The segments 24a-c can be interpreted as, as it were, cells 24a-c of the decomposition.

Based on a set of trajectory data 27, such as GNSS trajectory data 27, a road-accurate road map 14 can be produced that can correspond to a graph made up of nodes 11 and edges 13, where nodes 11 and edges 13 can represent a center line of the road. As an example, such a road-accurate road map 14 is illustrated in FIG. 3D.

In order to produce road-accurate road map 14, first the input data 16, 27 can be segmented, as described for FIG. 3A. For each cell 24a-c a graph can subsequently be initialized that can describe the traffic scenario of the respective segment 24a-c, or cell 24a-c. The goal here is to enable the models in the cells 24a-c, linked by boundary conditions, to be developed individually and subsequently fused to form a graph. As an example, the production of a road-accurate road map 14 is shown in FIGS. 3B-3D for road segment 24c from FIG. 3A. Here, FIG. 3B shows a cell 24c, or segment 24c, and vehicle trajectories 27. FIG. 3C shows an initial road map 14, and FIG. 3D shows an optimized road map 14. Road maps 14 of FIGS. 3C and 3D can also be designated cell graph 14.

For the initialization, first all cell boundaries 25 can be intersected with trajectories 27 in order to ascertain the road centers at the cell edges 25, as shown in FIG. 3B. These centers can be plotted in the graphs of the corresponding cells 24c as nodes 11, as shown in FIG. 3C. In addition, in each cell 24c the focal point of cell 24c can be inserted into the graph as node 11, and can be connected by edges 13 to nodes 11, at cell edges 25.

In order to link the trajectory data 27 and the model, or cell graph, an evaluation metric can be introduced that describes how well the models map the data. Here, on the one hand the distance between the models and the trajectory data 27, and on the other hand the differences in the direction of travel, can be taken into account. In order to optimize the models and to produce the final road-accurate road map 16, as shown in FIG. 3D, a reversible jump Markov chain Monte Carlo (RJMCMC) method can be used. Here, the trajectory data 27 are regarded as the realization of a random experiment whose distribution is implied by the underlying road network. The goal of the method is to reconstruct the unknown distribution, in this case the road network. Here, the models are varied randomly, independently of trajectory data 27, and subsequently a decision can be made as to whether to accept or reject the change based on the evaluation metric. The random variation of the models takes place through the random selection of prescribed change operations. Available for selection are for example a move operation, a producing operation, a removal operation, a dividing operation, and/or a fusing operation. In the move operation, a node 11 of a cell graph 24c is moved in space. The producing operation describes the addition of a new node 11 in graph 24c, and forms a reversible pair of operations together with the remove operation. The fuse operation inserts a node 11 into an adjacent edge 13, so that two edges 13 situated close to one another are unified in parts. The dividing operation dismantles such a construct, and is thus the opposite of the fuse operation. The presence of reversible pairs can be advantageous for a correct stochastic description of the process. As can be seen from a comparison of FIGS. 3C and 3D, during the optimization the center node 11 is removed, because it is not required for the description of road 17.

FIGS. 4A through 4C each illustrate steps of a method for producing a lane-accurate road map 22 according to an exemplary embodiment of the present invention. Specifically, in FIG. 4A a road-accurate road map 14 is shown. FIG. 4B illustrates a parameterization, and FIG. 4C illustrates a segmenting of road 17 of road map 14. In addition, FIGS. 5A through 5C each show a road model 28 according to an exemplary embodiment of the present invention. Specifically, FIG. 5A shows a connection block 30 of road model 28, FIG. 5B shows a road block 32 of road model 28, and FIG. 5C shows geometrical and topological parameter matrices of connection block 30 of FIG. 5A.

FIG. 4A shows a road-accurate graph 14 and/or a road-accurate road map 14, describing a road 17 and, at each of the ends, an intersection 19, using nodes 11 and edges 13. In order to transfer road 17 into a lane-accurate road map 22, road 17 is first parameterized one-dimensionally. In this way, as is shown in FIG. 4B, each point p of road 17 can be described via a value p∈[0; 1] of the unit interval.

Based on this parameterization, road segments 26 can be defined, as shown in FIG. 4C. In other words, road 17 is divided into one or more road segments 26 that can be identified for example based on nodes 11 and/or edges 13.

The segmenting of road 17 into road segments 26 can make it possible to describe traffic situations at the lane level in road model 28, as is illustrated in FIGS. 5A through 5C. Here, driving on a constant number of lanes 23 is distinguished from the widening or narrowing of road 17 by a lane 23.

A general road block 32, as shown in FIG. 5B, can have a number parameter L for describing the number of lanes 23, a width parameter W for describing a width of individual lanes 23, a curvature parameter C for describing a curvature of a road 17, and a distance parameter G for describing a distance between adjacent lanes 23 having opposite directions of travel. Road block 28 can also have a type parameter T for describing a type of a roadway marking for each lane 23. Parameter G can be a size of a constructive separation between the lanes 23 traveling in opposite directions.

A general road block 32 can thus be defined by the variable

B=(L,W,T,G,C).

A road 17 is thus defined as a set ξₛ of m road segments 26 and their parameterization values P, which describe the longitudinal extension on road 17, according to FIGS. 4A through 4C:

ξₛ=({P₁, . . . ,Pₘ₊₁},{B₁, . . . ,Bₘ})

In order to represent a curved road segment 26, all connections of lanes 23 on road segment 26 can be described by cubic Hermite polynomials. In this way, it is possible for a road segment 26 not only to have a constant curvature, but also to assume any course, where only the boundary conditions of continuity and differentiability are maintained in order to produce a realistic roadway course. The boundary conditions are introduced by specifying the connection points and the slope, or the slope vector, at the connection points. In order to influence the course of the polynomials, the magnitude of the slope vectors is accessible, or integrated, as parameter C in road model 28.

A general road block 32, also designated B, in the following, can be specified through further limitations or supplementations. A road block 32, as shown in FIG. 5B, contains the limitation that the number L of lanes 23 in the respective road segment 26 remains constant. In this way, a segment of road can be mapped on which only the inherent properties change, such as lane width W. In FIG. 5B, lanes 23 are identified with characteristic values −1, −2, +1, +2, where the sign indicates a direction of travel and the lanes in each direction of travel are numbered by progressive natural numbers 1, 2.

A connection block 30, also designated B_{c}, in the following, as shown in FIG. 5A, describes a traffic situation in which the number L of lanes 23 changes, and in which a combination or splitting of lanes 23 can therefore be modeled. Therefore, connection block 30 is supplemented, relative to road block 32, through a connection permutation R=(R_{GR}, R_{TR}, R_{GL}, R_{TL}), which both geometrically describes which lane 23 disappears, or is produced, and also topologically defines which lanes 23 are connected. As shown in FIG. 5C, for each direction of travel an individual geometrical parameter matrix R_{GR}, R_{GL}, and a topological parameter matrix R_{TR}, R_{TL}, are indicated. An existing item of information, or connectedness, of lanes 23 is illustrated in binary fashion by a one, and non-connectedness is illustrated by a zero, as shown in FIG. 5C. Also, in FIGS. 5A and 5C lanes 23 are identified with characteristic values −1, −2, +1, +2, where the sign indicates a direction of travel and the lanes 23 of each direction of travel are numbered with progressive natural numbers 1, 2. For example, in the situation shown in FIG. 5A it is topologically possible on the left side to change from the lane −1 to the new lane −2, or to remain in the present lane. This topological information is not synonymous with a simple lane change maneuver, which can be implied by the type of roadway marking. A connection block 30 can therefore be defined as

B_{c}=(BR).

In addition to these limitations of road model 30, it can in addition be provided that a connection block 30 is situated between two road blocks 32, in order to compensate, if needed, the differences between road blocks 32 (e.g. with regard to number of lanes L). If no changes are necessary, connection block 30 can be a special case of a road block 32.

FIGS. 6A through 6D each illustrate an intersection model 34 according to an exemplary embodiment of the present invention. Specifically, FIGS. 6A and 6B show an external intersection model 36 of intersection model 34, FIG. 6C shows an internal intersection model 38 of intersection model 34, and FIG. 6D shows a factor matrix F of the internal intersection model of FIG. 6C.

In the previous representation of a road map 14, as shown for example in FIG. 4A, an intersection 19 was represented by a node 11 that is connected to more than two edges 13. For the lane-accurate mapping and/or modeling of an intersection 19, both geometrical information about an intersection surface 37 and/or a navigable surface 37, or intersection surface 37, and also topological information about the connectivity of the incoming and outgoing lanes 23 and their path over intersection surface 37 are required. For this purpose, road-accurate road map 14 is first segmented into at least one intersection segment 19a, and/or an intersection segment 19a is identified in road-accurate road map 14. Intersection segment 19a is then modeled in an internal intersection model 38 and an external intersection model 36, as is explained in more detail below.

Intersection model 34, in the following also designated ξ_{c}, is made up of two different individual models. In FIGS. 6A and 6B, an external intersection model 36, in the following also designated ξ_{c,o}, is shown. For the initialization, nodes 11 of road-accurate road map 14 are examined, and intersection nodes 35 are identified on the basis of the connected edges 13. Because a large intersection 19 in road-accurate road map 14 can be described by a plurality of nodes 11, if necessary a plurality of nodes 11 can be combined with the aid of a distance value d_{cr}. External intersection model 36 can be produced at the center of the involved nodes 11. On the basis of the identified intersection nodes 35, the information can be gained directly as to how many roads 17 are connected to intersection 19. For each road 17, an intersection arm A1-A4 is produced. Each intersection arm A1-A4 has a distance parameter d that describes the distance from the center to the beginning of intersection surface 37 in relation to this intersection arm A1-A4, and defines an angle parameter a that defines an angle of rotation relative to a reference direction, for example east. Through these two parameters d, a, a transition point from road 17 into intersection surface 37 is defined for each intersection arm A1-A4.

The internal intersection model 38, also designated ξ_{c,i} in the following, is illustrated in FIGS. 6C and 6D. Internal intersection model 38 describes the connectivity of lanes 23. Each intersection arm A1-A4 here has the same information as a general road block 32 of road model 28, thereby defining the geometry of the connected roads 17. Between each incoming and outgoing lane 23 there can be a connection whose course can be described by a cubic Hermite polynomial. Thus, each connection is influenced by a parameter C, which can specify the course over intersection surface 37. Parameter C is stored in factor matrix F, as is shown in FIG. 6D, where a value of zero indicates that the connection does not exist. Through the identification of the external lane courses, in addition the limits of intersection surface 37 are defined. Here, factor matrix F can have a line and a column for each direction of travel and each intersection arm A1-A4. For clarity, different directions of travel are illustrated by different signs of the indices in FIG. 6D. In addition, lanes 23 of individual intersection arms A1-A4 in FIG. 6D are progressively numbered with natural numbers.

In the following, details are described of the road model 28 described in the preceding Figures, in particular FIGS. 4A through 6D, of intersection model 32, and the method according to the present invention for producing lane-accurate road map 22.

For the initialization of models 28, 34, road-accurate road map 14 is divided into roads 17 and intersections 19. At each intersection 19, an initial intersection model 35 is produced having an arm distance of dᵢₙᵢₜ=25 m, where the number of connected roads 17, and thus the angle parameters a of intersection arms A1-A4, are determined from road map 14. Subsequently, road models 28 between intersections 19 are generated, where a road 17 is described in the graph by a chain {vₓ, . . . , v_{y}}. In the lane-accurate road model 28, a connection block 30 is produced at each node 11, and between them a road block 32 is produced. Each road 17 begins and ends with a connection block 30 that can, if necessary, correct the differences between the adjoining road block 32 and the intersection connection. Each road 17 is initialized as having two lanes, with one lane 23 per direction of travel. The totality of the a road models 28 and b intersection models 34 is designated in the following as Φ={ξₛ¹, . . . , ξₛ^{a}ξ_{c}¹, . . . , ξ_{c}^{b}}.

The initialized models 28, 34, Φ represent the current configuration of the overall model. The parameters of these models are the described properties or parameters of road blocks 32, of connection blocks 30, of internal intersection models 36, and of external intersection models 38. These are to be varied using an RJMCMC method; therefore, in the following the possible change operations and the corresponding transition kernels are introduced. For all models 28, 30, 32, 34, 36, 38, on the one hand there are change operations that influence only the values of the existing parameters, and on the other hand there are change operations that modify the dimension of a model 28, 30, 32, 34, 36, 38.

FIGS. 7A through 7E each illustrate change operations 40, 41, 42, 43, 44, 46, 48, 50 according to an exemplary embodiment of the present invention. Specifically, FIG. 7A illustrates, at the left, an insert operation 40 for inserting a connection block 30 into a road block 32, and a fuse operation 41 for fusing two road blocks 32 and a connection block 30 to form a road block 32, as a reversible change operation 41 to insert operation 40. In addition, at the right FIG. 7A illustrates an adaptation operation 42 for adapting a parameterization value for parameterizing a longitudinal extension of a road 17. FIG. 7B illustrates an addition operation 43 for adding a lane 23 and a removal operation 44 for removing a lane 23. In addition, FIG. 7C shows a distance adaptation operation 46 for adapting a distance G between lanes 23 having opposite directions of travel, FIG. 7D shows a width adaptation operation 48 for adapting a width W of a lane 23, and FIG. 7E shows a curve adaptation operation 50 for adapting a curvature C of a road 17.

With regard to a road model 28, the change operations 40, 41, 42, 43, 44, 46, 48, 50 are further divided into two classes. Insertion operation 40, fusing operation 41, and adaptation operation 42, as shown in FIG. 7A, change road model 28 at the block level; i.e. the individual properties are not changed, but rather only the number of road blocks 32 and connection block 30, and their spatial extension, are changed. In addition operation 43, an existing road block 32 is divided into two road blocks 32 and one connection block 30. Remove operation 44 correspondingly connects such a constellation, and forms with addition operation 43 a reversible pair whose selection probabilities can be selected such that the expanded detailed balance condition is met. Adaptation operation 42 changes the limits of a road block 32 and/or connection block 30 with regard to the parameterization of road model 28. Addition operation 43, remove operation 44, distance adaptation operation 46, width adaptation operation 48, and curvature adaptation operation 50 change the properties or parameter values of a road block 32.

The parameter values of a road block 30 cannot be changed actively, but only passively. They adapt their parameters to the adjoining road blocks 32. The addition operation 43 for adding a lane 23, and a remove operation 44, likewise form a reversible pair, while the three adjustment operations 42, 46, 50 merely change the values of the parameters.

In order not to prefer any of the change operations 40, 41, 42, 43, 44, 46, 48, 50 in the random variation of parameter values of road model 28 and/or of intersection model 34, or to select each of the change operations 40, 41, 42, 43, 44, 46, 48, 50 with equal probability, the selection probabilities ω₄₀, ω₄₁, ω₄₂, ω₄₃,ω₄₄, ω₄₆, ω₄₈, ω₅₀ of all change operations 40, 41, 42, 43, 44, 46, 48, 50 are assumed to be identical:

ω₄₀=ω₄₁=ω₄₂=ω₄₃=ω₄₄=ω₄₆=ω₄₈=Ω₅₀, where

Σ_{ω}=1

In the following, the individual change operations 40, 41, 42, 43, 44, 46, 48, 50 are considered in more detail.

The transition from the representation at top in FIG. 7A to the representation at left in FIG. 7A takes place via insertion operation 40. The longitudinal extension of road block 32 to be divided, Bₛ is defined via the parameterization P of road model ξₛ with the values (pₛ, pₑ)∈P, with the parameterized length p₁=pₑ−pₛ. For the division, two new values u₁,u₂∈[0,pₗ]

on this length are required, with u₁<u₂:

τ₄₀(P,u₁, u₂)=(P,pₛ+u₁pₛ+u₂),

with P′={p₁, . . . ,pₛ,pₛ+u₁,pₛ+u₂,pₑ, . . . ,pₘ₊₁},

u₁,u₂˜q₄₀(s⁽ⁿ⁺¹)|s⁽ⁿ⁾)=U(0,pᵢ)∈

[symbol]

The probability of acceptance is determined as:

$${A}_{40} ( {s}^{′} \vert {s}^{( n )} , \vec{u} ) = min \{ 1 , \frac{π ( {s}^{′} )}{π ( {s}^{( n )} )} \cdot \frac{\vert ( {τ}_{40} )}{{p}_{l}^{2}} \} .$$

The Jacobi matrix of the transformation is

$$( {τ}_{40} ) = ( \begin{matrix}1 & 0 & 0 \\ \frac{\partial ( {p}_{s} + {u}_{1} )}{\partial P} & 1 & 0 \\ \frac{\partial ( {p}_{s} + {u}_{2} )}{\partial P} & 0 & 1\end{matrix} )$$

having a determinant of 1, because the matrix is triangular.

Fusing operation 41 can be regarded as the converse case. The constellation of road block 32, connection block 30, road block 32 is combined, and for the transformation no new components are required, but rather are calculated. The constellation is defined in the parameterization P of road model 28, by the sequence {pₐ, p_{b}, p_{c}, p_{d}}. The acceptance probability is:

A₄₁(s′|s⁽ⁿ⁾)=A₄₁(s⁽ⁿ⁾|s′,\vec{u})⁻¹,

with u₁=p_{b}−pₐ,u₂=p_{c}−pₐ.

Adaptation operation 42 describes, as transition between the upper representation in FIG. 7A and the representation at right in FIG. 7A, the change of one of the two parameterization values of a road block 32. Here, the parameter can be changed by a maximum of half the parameterized length p₁ of road block 32. In order not to prefer a direction of movement, the search function is realized as a random movement:

$$δ p ∼ {q}_{42} ( {s}^{( n + 1 )} \vert {s}^{( n )} ) = U ( - \frac{{p}_{l}}{2} , \frac{{p}_{l}}{2} ) ∈ .$$

In order to insert a new lane width addition operation 43, as shown in FIG. 7B, road model 28 is supplemented by a new lane width of a lane 23. The new lane width is drawn from a normal distribution whose expected value and variance result from road construction specifications. These can be determined in the context of the scenario or type of road 17. For the transformation there follows:

τ₄₃(W,u)=(W,u)

u˜q₄₃(s⁽ⁿ⁺¹⁾|s⁽ⁿ⁾)=N(μ₄₃,σ_{add}²).

The determinant of the Jacobi matrix is 1 and the acceptance probability results as:

$${A}_{43} ( {s}^{′} \vert {s}^{( n )} , u ) = min \{ 1 , \frac{π ( {s}^{′} )}{π ( {s}^{( n )} )} \cdot \frac{\vert ( {τ}_{43} ) \vert}{\sqrt{2 {πσ}_{43}^{2}}} \cdot {e}^{- \frac{{( u - {u}_{43} )}^{2}}{2 {πσ}_{43}^{2}}} \} .$$

The acceptance probability for the opposite, removal operation 44 is calculated correspondingly, where the component u is the lane width of lane 23 to be removed:

A₄₄(s′|s⁽ⁿ⁾)=A₄₄(s⁽ⁿ⁾|s′,u)⁻¹.

The three change operations 46, 48, 50 shown in FIGS. 7C, 7D, 7E change the existing parameter values of road model 28 and of the intersection model. Therefore, the corresponding search functions are realized as an equal distribution:

δg˜q₄₆(s⁽ⁿ⁺¹⁾|s⁽ⁿ⁾)=U(0,σ₄₆)∈

[symbol]

δw˜q₄₈(s⁽ⁿ⁺¹⁾|s⁽ⁿ⁾)=U(0,σ₄₈)∈

[symbol]

δc˜q₅₀(s⁽ⁿ⁺¹⁾|s⁽ⁿ⁾)=U(0,σ₅₀)∈

[symbol]

Because intersection model 34 is made up of internal intersection model 36 and external intersection model 38, there are different change operations for each submodel 36, 38. As shown in FIGS. 6A and 6B, the two parameters distance d and angle a influence the form of external intersection model 36. The number of intersection arms A1-A4 is already extracted from road map 14 in the initialization process, and is not changed again. Thus, two change operations are defined that change the two parameters d, a, but not the dimension of external intersection model 36. In other words, the external intersection model can have a distance parameter change operation and an angle parameter change operation. Therefore, search functions are realized as a uniform distribution:

δd˜q_{d}(s⁽ⁿ⁺¹⁾|s⁽ⁿ⁾)=U(0,σ_{d})∈

[symbol]

δα˜qₐ(s⁽ⁿ⁺¹⁾|s⁽ⁿ⁾)=U(0,σₐ)∈

[symbol]

In internal intersection model 38, each intersection arm A1-A4 has a connection cross-section that has the same properties as a road block 32. Because a connection block 30 is connected to each intersection arm A1-A4, this block reacts to the changes in intersection arm A1-A4 exactly as it does to changes in a road block 32. Therefore, the change operations for varying the connection properties are identical to the already defined operations of a road block 32. In other words, the internal intersection model 38 has the above-described change operations 40, 41, 42, 43, 44, 46, 48, 50. The influencing of the factor matrix F from FIG. 6D is not done through an RJMCMC operation.

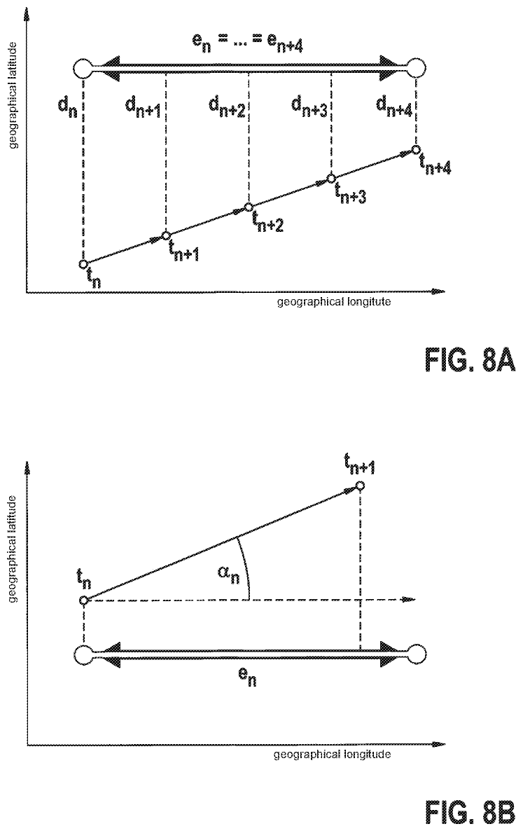

FIGS. 8A and 8B each illustrate an application of an evaluation metric according to an exemplary embodiment of the present invention.

For the evaluations, on the one hand a measure is taken into account concerning the agreement between road model 28 and/or intersection model 34 and the trajectory data 27, in a first term π_{d}^{l}, and on the other hand previous knowledge about the models 28, 34 is taken into account in a second term πₚ^{l}. In the following, these measures are presented.

In the first step, the vehicle trajectories 27 are mapped onto lanes 23. For this purpose, first each center line of each road segment 26 and of each intersection 19 is transferred into a graph, the center line being discretized in small steps with nodes 11 and edges 13. Each graph is subsequently optimized to a minimum number of nodes 11, using the Douglas-Peucker algorithm. Subsequently, these graphs are fused to form an overall representation G.

$${ϒ}_{d} ( {e}_{n} , {t}_{n} ) = p ( {t}_{n} \vert {e}_{n} ) = p ( {d}_{n} ) = \frac{1}{\sqrt{2 {πσ}_{t}^{2}}} \cdot {e}^{- \frac{1}{2} {( \frac{{d}_{n}}{{σ}_{t}} )}^{2}}$$

In the next step, for each trajectory 27 a hidden Markov model (HMM) is produced that has as hidden states the edges 13 of the generated graph G and has as emitted observations the trajectory points. The HMM is solved using the Viterbi algorithm and yields the most probable allocation of each measurement point to a lane 23:

$${ϒ}_{α} ( γ ( {e}_{n} ) , γ ( {t}_{n} ) ) = p ( γ ( {t}_{n} ) \vert γ ( {e}_{n} ) ) = p ( {α}_{n} ) = \frac{1}{\sqrt{2 {πσ}_{α}^{2}}} \cdot {e}^{- \frac{1}{2} {( \frac{{α}_{n}}{{σ}_{α}} )}^{2}} .$$

As evaluation measure, the Euclidean distance Y_{d} between the trajectory and the lane according to FIG. 8A, as well as the enclosed driving angle Y_{α} according to FIG. 8B are evaluated. In addition, a boundary value for the minimum number of transits is introduced. Y_{f} describes a jump function that has the effect that lanes having too few transits are rated as unreliable and the configuration is rejected. In general, the definition of the function is a function of the overall number of transits, and may be realized such that a particular value is evaluated as the normal number, and a deviation from this results in rejection. The first term of the evaluation metric is thus given by:

$${π}_{d}^{l} = {\sum }_{t ∈ T} {\sum }_{n ∈ m} [ log ( {ϒ}_{d} ( G ( {t}_{n} ) , {t}_{n} ) ) + log ( {ϒ}_{α} ( γ ( G ( {t}_{n} ) ) , {t}_{n} ) ) ] + {\sum }_{ξ ∈ Φ} log ( {ϒ}_{f} ( ξ , T ) ) \\ G ( {t}_{n} ) = arg {max}_{\overline{e} ∈ G} p ( \overline{e} \vert {t}_{n} ) = {e}_{n}$$

The jump function for taking into account the transits is defined as:

$${ϒ}_{f} ( ξ , T ) = \{ \begin{matrix}1 , & if {\sum }_{x ∈ L ( ξ )} x T > η \\ 0 , & otherwise\end{matrix}$$

where L(ξ) describes the lanes of the model, x [symbol] T describes the number of trajectories mapped onto the xth lane, and η describes the minimum number of transits to be reached.

In πₚ^{l}, previous knowledge about lane-accurate models 28, 34 is taken into account. In order to keep the road segments and intersections 19 realistic, regularization terms are introduced that influence the development of the properties. Here, the width of a lane and the length of a block are regulated:

πₚ^{l}=π_{p,lanewidth}^{l}+π_{p,roadsegmentlength}^{l}

With regard to lane width w, a normal distribution is assumed whose parameters are to be selected in the context of the scenario. Characteristic variables for different scenarios can be taken from various guidelines for road construction.

$${π}_{p , lanewidth}^{l} = log ( \frac{1}{\sqrt{2 {πσ}_{l w}^{2}}} \cdot {e}^{- \frac{{( w - {μ}_{lw} )}^{2}}{{σ}_{l w}^{2}}} )$$

In this method, overfitting would arise from a stringing together of very short road segments 26. In order to counteract this, a minimum length for a road segment is introduced, realized by the regulation with the aid of a jump function:

$${π}_{p , roadsegmentlength}^{l} = log \{ \begin{matrix}1 , & if roadsegmentlength > κ \\ 0 , & otherwise\end{matrix}$$

After all road models 28 and intersection models 35 have been initialized, the method can be varied using the defined RJMCMC change operations 40, 41, 42, 43, 44, 46, 48, 50. For this purpose, a target function

π=δπ_{d}^{l}+(1−δ)λₚ^{l}

is ascertained that determines both the agreement between the trajectory data 27 and the models 28, 34 in π_{d}^{l} and also existing knowledge concerning developments that are to be avoided and that are to be reinforced of models 28, 34 in πₚ^{l}, where δ∈[0; 1] determines the ratio between the data knowledge and the model knowledge.

A corresponding algorithm for carrying out the method according to the present invention can be divided into a warm-up phase and a main phase. In the warm-up phase, for example not all change operations 40, 41, 42, 43, 44, 46, 48, 50 may be available; rather, it is possible for only distance adaptation operation 46 of road model 28 or intersection model 34 to be used. The problem that this measure addresses occurs when there are roads having a large constructive separation: given an equally justified selection of the operations and an initial model not having the constructive separation, the method can quickly produce a model having a large number of lanes. It then takes many iterations to exchange the superfluous lanes 23 for a constructive separation. The warm-up phase can make it possible to achieve a better initial estimation of the separation in very few iterations.

In addition, the so-called simulated annealing method can be used, whose purpose is to influence the above-described target function as a function of the run time:

π∝π^{1/t}^{_{SA}}^{⁽ⁿ⁾}^{(ξ)}

where the function t_{SA}⁽ⁿ⁾(ξ) for each cell represents a cooling function with

$${lim}_{n -> ∞} {t}_{SA}^{( n )} ( ξ ) = 0$$

As a result, the formation of the Markov chain can concentrate on better-evaluated regions of the target function. In practice, this means that change operations that make the evaluation worse as the runtime progresses are more rarely accepted. The value of the cooling function decreases as soon as a proposed change operation is rejected. The cooling function is an exponentially decreasing function:

t_{SA}⁽ⁿ⁾(ξ)=e^{-λn}ϵ[0; 1],

where the parameter λ is selected such that a specified number of steps s are required to reach a temperature eps≈0. For this purpose, the function is transformed into a calculating rule as a function of the number of steps:

$$λ = - \frac{10 log ( eps )}{s}$$

In addition, it is to be noted that “including” does not exclude any other elements, and “a” or “one” does not exclude a plurality. In addition, it is to be noted that features that have been described with reference to one of the above exemplary embodiments can also be used in combination with other features of other exemplary embodiments described above. Reference characters in the claims are not to be regarded as limiting.

1-12. (canceled)

13. A method for producing a lane-accurate road map, the method comprising the following steps:
providing a digital road-accurate road map for describing a course of at least one road;
providing a trajectory data record that has a plurality of trajectory data of traffic participants along the at least one road;
identifying the at least one road, with segmenting of the road-accurate road map into at least one road segment;
modeling the road segment in at least one road model, the road model having a plurality of parameters for the geometrical and/or topological description of lanes of the road;
randomly varying parameter values of at least a part of the parameters of the road model through random selection of a change operation of the road model to change parameter values;
assigning at least a part of the trajectory data of the trajectory data record to the road model, including ascertaining at least one probability value for the road model, the probability value correlating with a quality of a mapping of the trajectory data by the road model;
ascertaining, based on the ascertained at least one probability value, optimal parameter values of at least a part of the parameters of the road model; and
producing a lane-accurate road map based on the optimal parameter values of the road model.

14. The method as recited in claim 13, wherein the optimal parameter values are ascertained based on a Monte Carlo method.

15. The method as recited in claim 14, wherein the Monte Carlo method is a reversible jump Markov chain Monte Carlo method.

16. The method as recited in claim 13, wherein:
the road model has at least one road block for modeling a number of lanes that is constant at least in a partial area of the road segment; and/or
the road model has at least one connection block for modeling, based on at least one geometrical parameter matrix and at least one topological parameter matrix, a number of lanes that changes at least in a partial area of the road segment, values of the geometrical parameter matrix describing a change of the number of lanes within the road segment, and values of the topological parameter matrix describe a connection between individual lanes within the road segment.

17. The method as recited in claim 13, wherein the modeling of the road segment in the road model includes the following substeps:
parameterizing the road segment in a unit interval, so that each point of the road in the road segment is defined via a parameterization value in the unit interval;
segmenting the road segment into at least one road block and at least one connection block of the road model;
modeling a disappearance or a production of a lane within the road segment based on at least one geometrical parameter matrix of the connection block;
modeling a connection of individual lanes within the road segment based on at least one topological parameter matrix of the connection block; and
ascertaining values of the geometrical parameter matrix and/or values of the topological parameter matrix, based on a random selection of a change operation of the road model.

18. The method as recited in claim 13, wherein the digital road-accurate road map has at least one intersection and a plurality of roads connected to the intersection, the method further comprising the following steps:
identifying the at least one intersection with segmenting of the road-accurate road map into at least one intersection segment;
modeling the intersection segment in at least one intersection model, the intersection model having a plurality of parameters for the geometrical and/or topological description of lanes of the intersection;
randomly varying parameter values of at least a part of the parameters of the intersection model through random selection of a change operation of the intersection model to change parameter values;
assigning at least a part of the trajectory data of the trajectory data record to the intersection model, including ascertaining at least one probability value for the intersection model, the probability value correlating with a quality of a mapping of the trajectory data by the intersection model;
ascertaining, based on the ascertained at least one probability value, optimal parameter values of at least a part of the parameters of the intersection model; and
producing a lane-accurate road map based on the optimal parameter values of the intersection model.

19. The method as recited in claim 18, wherein:
the intersection model has an external intersection model for modeling a navigable intersection surface of the intersection, based on a distance parameter and an angle parameter; and/or
the step of modeling of the intersection segment in the intersection model includes the following substeps:
ascertaining an intersection node in the road-accurate road map;
ascertaining a number of edges, connected to the intersection node, of the road-accurate road map, including ascertaining of a number of roads connected to the intersection; and
generating a number of intersection arms that corresponds to the number of roads connected to the intersection, each of the intersection arms being defined by a distance parameter for indicating a distance of a center of the intersection from a limit surface of the intersection along the respective intersection arm, each of the intersection arms being defined by an angle parameter for indicating an angle of rotation between the respective intersection arm and a reference direction.

20. The method as recited in claim 18, wherein:
the intersection model had an internal intersection model for modeling, based on a factor matrix of the intersection model, lanes leading into the intersection, lanes leading out from the intersection, and a course of lanes over an intersection surface of the intersection; and/or
the step of modeling of the intersection segment in the intersection model includes the following substeps:
modeling at least a part of lanes leading into the intersection, at least a part of lanes leading out from the intersection, and a course of at least a part of lanes leading over the intersection surface of the intersection, based on a factor matrix, values of the factor matrix describing a course and a connection of lanes over the intersection surface; and
ascertaining values of the factor matrix based on at least a part of the trajectory data of the trajectory data record.

21. The method as recited in claim 13, wherein the road model and/or an intersection model each have a number parameter for describing a number of lanes, a width parameter for describing a width of individual lanes, a curvature parameter for describing a curvature of a road, and a distance parameter for describing a distance between lanes having opposite directions of travel.

22. The method as recited in claim 13, wherein the road model and/or an intersection model include: at least one change operation selected from the list made up of: an insert operation for inserting a connection block into a road block, a fuse operation for fusing two road blocks and a connection block to form a road block, an adaptation operation for adapting a parameterization value for parameterizing a longitudinal extension of a road, an addition operation for adding a lane, a remove operation for removing a lane, a distance adaptation operation for adapting a distance between lanes having opposite directions of travel, a width adaptation operation for adapting a width of a lane, and a curvature adaptation operation for adapting a curvature of a road.

23. The method as recited in claim 13, the method further comprising the following step:
rejecting or accepting parameter values varied randomly based on the random selection of a change operation, and/or based on an evaluation metric that describes the quality of the mapping of the trajectory data by the road model and/or based on an intersection model;
wherein the evaluation metric has a first term for describing an agreement between the trajectory data and the road model and/or an intersection model;
wherein the evaluation metric has a second term for taking into account at least one prespecified characteristic variable of a road geometry, the characteristic variable relating to a lane width and/or a road width.

24. A data processing device for ascertaining a lane-accurate road map based on a digital road-accurate road map, the data processing device being configured to:
provide a digital road-accurate road map for describing a course of at least one road;
provide a trajectory data record that has a plurality of trajectory data of traffic participants along the at least one road;
identify the at least one road, with segmenting of the road-accurate road map into at least one road segment;
model the road segment in at least one road model, the road model having a plurality of parameters for the geometrical and/or topological description of lanes of the road;
randomly vary parameter values of at least a part of the parameters of the road model through random selection of a change operation of the road model to change parameter values;
assign at least a part of the trajectory data of the trajectory data record to the road model, including ascertaining at least one probability value for the road model, the probability value correlating with a quality of a mapping of the trajectory data by the road model;
ascertain, based on the ascertained at least one probability value, optimal parameter values of at least a part of the parameters of the road model; and
produce a lane-accurate road map based on the optimal parameter values of the road model.

25. The data processing device as recited in claim 24, wherein the data processing device has a data storage device for storing the digital road-accurate road map and a processor.
